(19) United States
(12) Patent Application Publication
(10) Pub. No.: US 2011/0130114 A1
(43) Pub. Date: Jun. 2, 2011

(54) Safety device for enhanced pedestrian protection

(76) Inventor: Wesley John Boudville, Perth (AU)

(21) Appl. No.: 12/592,513

(22) Filed: Nov. 27, 2009

(51) Int. Cl. H04M 11/04; G06K 9/00; H04W 4/00

(52) U.S. Cl. 455/404.2; 382/115; 455/426.1; 382/103

(57) ABSTRACT

A safety device (SD) with wireless ability, and fixed and mobile, multispectral sensors in an urban region is used for improved protection of a pedestrian, who contacts it via a cellphone. SD tracks and records her and her interactions with others, who might also be tracked if the interactions are suspicious. SD offers her access to a Safety Kiosk (SK) as a shelter against a possible hostile person, where the SK is a multipurposed structure with some other primary use, like an Automated Teller Machine enclosure. SD can archive messages and calendar data associated with the pedestrian and germane to upcoming meetings with others.

### REFERENCES CITED

“Multi-Camera Networks” by H Aghajan et al, Academic Press 2009, 978-0123746337. [Aghajan]
“Ultra Wideband Systems” by R Aiello et al, Newnes 2006, 978-0750678933. [Aiello]
“Mechantronics and Machine Vision in Practice”, edited by J Billingsley and R Bradbeer, Springer 2008, 978-3540740261. [Billingsley]
“Algorithms and Protocols for Wireless, Mobile Ad Hoc Networks”, edited by A Boukerche, Wiley 2008, 978-0470383582. [Boukerche]
“Machine Vision” by E Davies, Morgan Kaufman 2005, 978-0122060939. [Davies]
“Optics” by E Hecht, Wiley 2001, 0805385665. [Hecht]
“Experimental Robotics (10th International Symposium)” edited by O Khatib et al, Springer 2008, 978-3540774563. [Khatib1]
“Experimental Robotics (11th International Symposium)” edited by O Khatib et al, Springer 2009, 978-3642001956. [Khatib2]
“Handbook of Multisensor Data Fusion”, edited by M Liggins et al, CRC 2009, 978-1420053081. [Liggins]
“Optical Character Recognition” by S Mori, Wiley 1999, 0471308196. [Mori]
“Feature Extraction and Image Process” by M Nixon et al, Academic 2008, 978-0123725387. [Nixon]
“Springer Handbook of Robotics”, edited by B Siciliano et al, Springer 2008, 978-3540239574. [Siciliano]
“imouse: An Integrated mobile surveillance and wireless sensor system” by Y-C Tseng et al, IEEE Computer 40 (6) 2007, pp 60-66. [Tseng]
“Ground-Based Wireless Positioning” by K Yu et al, Wiley 2009, 978-0470747049. [Yu]
“Occupant Sensing System” by Breed et al, U.S. Pat. No. 7,415,126, Aug. 19, 2008. [Breed]
“Apparatus and method for creating a virtual three-dimensional environment, and method for generating revenue therefrom” by Edecker et al, U.S. Pat. No. 7,570,261, Aug. 4, 2009. [Edecker]
“Pedestrian detection and tracking with night vision” by Fujimura et al, U.S. Pat. No. 7,139,411, Nov. 21, 2006. [Fujimura]
“Method and Apparatus for detecting and correcting malicious data in an ad-hoc network” by Golle et al, U.S. Pat. No. 7,362,711, Apr. 22, 2008. [Golle]
“Methods, Apparatus and Program Products for Applying a Visibility Function to Networked Information”, by Ghosh et al, U.S. Pat. No. 7,466,664, Dec. 16, 2008. [Ghosh]
“Mobile thing determination systems and methods based upon user-device location”, by Horstemeyer, U.S. Pat. No. 7,538,691, May 26, 2009. [Horstemeyer]
“Wireless virtual campus escort system” by Laird et al, U.S. Pat. No. 7,149,533, Dec. 12, 2006. [Laird]
“Targeting Location Through Haptic Feedback Signals” by Moloney, US Provisional Patent 20090076723, Mar. 19, 2009. [Moloney]
“Multi-view cognitive swarm for object recognition and 3d tracking” by Owechko et al, U.S. Pat. No. 7,558,762, Jul. 7, 2009.
[Owechko]
bluetooth.com
gps.gov
jini.org
wi-fi.org
en.wikipedia.org/wiki/Augmented_reality
en.wikipedia.org/wiki/Brain-computer_interface
en.wikipedia.org/wiki/Geofence
en.wikipedia.org/wiki/GLONASS
en.wikipedia.org/wiki/Beidou_navigation_system
en.wikipedia.org/wiki/Eigenface
en.wikipedia.org/wiki/Smart_camera
jcdecaux.com
nuance.com
setiathome.berkeley.edu
wimax.com
zigbee.org

### TECHNICAL FIELD

The invention relates to the use of cellphones and other mobile wireless computers, and imaging sensor systems, for improved personal security.

### BACKGROUND OF THE INVENTION

In recent years, the use of cellphones has become very common throughout the world. A parallel trend has been the rise of various other remote wireless protocols, like Bluetooth, Jini, WiFi, WiMax and ZigBee. One consequence has been the increasing ability of a given cellphone to support one or more of these other protocols.

Another observation is that many university campuses (at least in the US) have installed alarm posts. Typically a post has a prominent button, which a person in danger can press. The button triggers a flashing light on the post, possibly accompanied by a siren. Also, the post alerts the authorities by a wired or wireless connection. The post might also have an accompanying camera, though perhaps surprisingly, many do not.

Another trend has been the increasing use of cameras in urban areas. Some are installed by the authorities to surveil traffic or high crime regions. Others are installed by private companies, on their premises for related safety reasons. These typically cannot be manually accessed or alerted by someone in danger. The cameras are often just pointing at a fixed orientation, or they pan automatically. Possibly a camera that has pan and zoom ability might be able to be manually controlled by a human operator at a remote control room. The cameras and their control systems do not have image recognition software. So they might record everything to a storage medium, or in addition, a human operator performs the image recognition, by perhaps tracking a suspect. The main problem with using human operators is that they can be overwhelmed with the volume of data.

If human operators are to be used, it would be desirable to interpose automated logic to process the raw data feeds, and then perhaps inform the operators on an exception basis.

In the examples of the previous paragraphs, it also appears to be rare for a person to be able to alert those systems via wireless means.

While the scope of robotics research is vast, a good summary of current efforts for 2008-9 appears in [Khatib1-2].

Consider “Experiments with Simultaneous Environment Mapping and Multi-Target Tracking” by A Babu et al in [Khatib1]. Their robot has to detect and track mobile objects while also mapping its environment. Our invention assumes a robot uses precalculated knowledge of static (unchanging) elements in its environment, to simplify distinguishing a tracked object from that environment. Their work also relates to using a single mobile robot, while our invention involves multiple robots and non-robot sensors, and some/all of our-robots can be in fixed locations.

Consider “Multi-level State Estimation in an Outdoor Decentralised Sensor Network” by B Uperoft et al in [Khatib1]. A commonality with our invention is that they do data fusion using an autonomous aircraft and a ground vehicle. One difference is that they use human operators to also actively do data analysis. Another difference is that they do not do tracking of human subjects. Another difference is that a human subject cannot actively request and trigger a tracking by their system, while our invention permits and depends on this. Yet another difference is that their experiment was done in a largely rural environment, with (as far as we can ascertain) no precalculation of fixed objects in that environment, whereas we deal with urban settings and do precalculation.

Consider “Maintaining Connectivity in Mobile Robot Networks” by N Michael in [Khatib2]. Our invention differs in that our network of robot sensors can have fixed location robots, whereas Michael considers a network of all mobile robots. Perhaps more importantly, our network can have a superpeer, which is a central command node, which can aid in directing the mobile robots.

Consider “Visual Tracking for Teams of Miniature Robots” by H Min et al in [Khatib2]. The robots move in the same plane as the mobile target that they are tracking. We differ in that we can have fixed sensors aiding in the tracking. Also, we can have mobile robots not restricted to the plane of the target. And Min's robots do not use prior knowledge of the background against which the target is moving, in order to improve identification of the target.

Consider “Co-ordinated Tracking and Planning Using Air and Ground Vehicles” by A Bachrach et al in [Khatib2]. They do not and cannot use prior knowledge of the background, because this background might have been recently altered by explosion or fire. The context of their application is for a military or disaster region. Our application is for an urban civilian region, whose layout is known.

Consider “Motion Strategies for People Tracking” by T Bandyopadhyay et al in [Khatib2]. They do not use prior knowledge of a known background against which the target is moving, for improved identification. They only use mobile robots, without assistance from some fixed robots, as we do.

In general, with the above examples from [Khatib1-2], and from other research efforts in robotics, the focus is usually on the tracking of a given moving object. Why that given object has been chosen is typically outside the scope of the algorithms or experiments. It is a command level decision that is conveyed as an initial condition for the methods.

Consider “imouse: An integrated mobile surveillance and wireless sensor system” by Tseng et al in [Tseng]. They have a system of fixed and mobile sensors. Their sensors detect “unusual” events, like a high temperature, which is considered indicative of a fire, and then mobile sensors are dispatched to that vicinity, so that human operators can view through those sensors, viz. “On detecting a potential emergency, the server dispatches mobile sensors to visit emergency sites to obtain high-resolution images of the scene”. One difference with us is that their sensors are not triggered or contacted by a human requesting protective surveillance on and around herself. Another difference is that their system is largely reactive. Their mobile sensors are dispatched after static sensors detect unusual conditions. Another difference is that image recognition appears to play a minimal role in their system. The images found by them are analysed by a human operator. Another difference is that their mobile sensors do not have tracking ability. As quoted above, their sensors go to a fixed location of some unusual event.

Consider now the prior art in terms of granted patents.

Consider “Multi-view cognitive swarm for object recognition and 3d tracking” by [Owechko]. A difference is that their agents are not necessarily instantiated in mobile robots. The agents are software entities that execute in some hardware. Another difference is that the pedestrian does not contact the system with her cellphone. Another difference is that [Owechko] is not about the safety of the pedestrian. Another difference is that their system does not track someone that the pedestrian points her phone at.

Consider “Pedestrian detection and tracking with night vision” by [Fujimura]. A difference is that their invention is used by a vehicle to avoid hitting a pedestrian. Another difference is that the pedestrian does not communicate with the vehicle with her phone. Another difference is that the method does not protect the pedestrian from another pedestrian.

In general, [Fujimura] is typical of many patents that describe image recognition of pedestrians. These are written from the perspective of methods implemented in vehicles that want to avoid hitting a pedestrian.

Consider “Targeting Location Through Haptic Feedback Signals” by [Moloney]. It describes how to use haptic gloves with GPS and a gyroscope for a wearer to point to a target. This is the starting point for one of our optional extensions. But it does not impinge on other aspects of our invention, like image recognition, or the following of a person by a system of sensors, where some of these might be robots.

Consider “Wireless virtual campus escort system” by [Laird]. This is the closest prior art to our invention, in our estimation. Because of this, we have provided a detailed comparison below, after the description of our invention, in order to make it easier for the reader to understand. See “Section 12—Comparison with [Laird]”.

### SUMMARY

A safety device (SD) with wireless ability, and fixed and mobile, multispectral sensors in an urban region is used for improved protection of a pedestrian, who contacts it via a cellphone. SD tracks and records her and her interactions with others, who might also be tracked if the interactions are suspicious. SD offers her access to a Safety Kiosk (SK) as a shelter against a possible hostile person, where the SK is a multipurposed structure with some other primary use, like an Automated Teller Machine enclosure. SD can archive messages and calendar data associated with the pedestrian and germane to upcoming meetings with others.

### BRIEF DESCRIPTION OF THE DRAWINGS

Various embodiments of the invention are disclosed in the following detailed description and the accompanying drawings.

FIG. 1 is a diagram illustrating the main components of a Safety Device and how these interact with a pedestrian.

FIG. 2 is a diagram showing the Safety Device giving directions to the pedestrian to go to Safety Kiosks.

FIG. 3 is a diagram illustrating the Safety Device acting to backup a pedestrian's personal data, via an electronic agent on her wireless device.

### DETAILED DESCRIPTION OF THE PREFERRED EMBODIMENT

What we claim as new and desire to secure by letters patent is set forth in the following claims.

The invention has the sections:
1. Main Description
2. Locking a Car
3. Companion
4. Use of a VANET
5. Disabling a Suspect's Car
6. Electronic Agent
7. Embedded Cellphone
8. Optimising Device Workload
9. Competing Safety Devices
10. Safety Kiosk
11. Powered Wheelchair
12. Comparison with [Laird]
13. Archiving Appointment Data

### 1. Main Description

In what follows, we refer to a person, Jane, using a wireless computer. To be specific, she uses a cellphone. But this could be replaced by any other type of wireless computer, like a PDA, laptop or netbook, where these are imagined to have wireless capability.

We describe the use of the Global Positioning System (GPS). Other satellite systems could be used for positioning purposes, in conjunction with or in place of GPS, like the Russian Glonass, China's Beidou or Europe's Galileo.

Consider a Safety Device (SD), with spatially distributed components. It can have audible and visible alarms, located in some publicly accessible region, like a street or park. SD is able to contact emergency services like police, ambulance and fire brigade, where this might be done via a wired or wireless connection.

SD has one or more sensors. Preferably it has several. We use the term “sensor” as the general term for a detector that can record images, as in [Liggins]. A camera is a special case of a sensor, where typically the camera records in the visible or infrared spectrum. A non-camera sensor might be one that uses radar or which records sound. SD also has several antennas, for wireless communication, where these could be in various protocols, not limited to those used for cellphones.

If SD has several sensors, these might be in different locations. Preferably, the cameras can pan, tilt and zoom (PTZ). These would be directional cameras. But SD can also have omnidirectional cameras. The cameras and sensors might be under the central control of SD, with logic that controls the PTZ of each camera, and various other features of the sensors. Or some or most of the sensors might have (most of) their control logic collocated with their other instrumentation, like their optics, and the sensors have some, possibly limited, autonomy in deciding how to operate. These might be considered “Smart Cameras”.

Sensors might be mobile or in a fixed position. A mobile sensor could be considered as a robot that can move along the ground or along a wall, roof or ceiling of a building. Also, a (fixed) sensor might be attached to other objects, like a tree, sign post, street light or billboard.

The sensor could move along a fixed track embedded in or on a surface. Note that if a sensor moves along a wall, roof or ceiling, that it can preferably do so above the height of most people. This can aid in identifying and tracking a person, especially when she is moving in a crowd. This is distinct from many robotics methods, like those cited in [Khatib1-2], where a robot travels at ground level, and thus its view of its target might easily be occluded by other people or objects moving at ground level. The sensor might use a belt or pulley system to move along the track. Or the track and sensor might have a sprocket mechanism for movement. Other mechanisms might be used. The track provides the mechanical means for the sensor to be attached to the surface. Preferably, the track might provide power to the sensor. Plus data sent by the sensor to other nodes of the SD, or to a command node, or data sent from those to it, might also come via communication channels in the track. Here data also includes commands sent to or from the sensor. When data is sent along the track, it might be by a physical channel in the track different from a channel carrying power to the sensor. Or, the latter channel might be reused to also carry data as a modulation signal on the power. Instead of, or in addition to a communication channel along the track, the sensor could have wireless communication to other parts of the SD.

Another possibility for a mobile sensor is where it is attached to a wire or cable dangling in the air between supporting posts or walls.

Another type of mobile sensor is one attached to a vehicle that regularly traverses SD's region, where the vehicle is mainly used for another purpose. For example, the vehicle could be a bus or tram or garbage truck. If sensors become cheap (and powerful) enough, then emplacing them in these vehicles as they move through a region can improve SD's coverage. Here, the sensors are preferably able to PTZ independently of the vehicle's movement. These mobile sensors are considered passive, because they do not control their motion.

Note that we define a passive mobile sensor to mean moving along a limited, fixed trajectory, or in a trajectory outside the control of the sensor. Whereas an active mobile sensor has its trajectory under its own control.

Some sensors might be airborne. Perhaps in a tethered or non-tethered balloon. Or in a heavier than air vehicle. Both types have been used by militaries for long term aerial reconnaissance. In this invention, they can likewise be used for civilian applications. Both types might be manned or unmanned, though preferably unmanned due to cost savings by automation.

Optionally, SD's sensors may be considered to be a network of sensors under the central control of a command node, where the latter might be fixed in location. In general, the network has heterogeneous nodes; i.e. they have differing capabilities. Individual nodes, especially if mobile, might also have local abilities that enable some autonomy in making decisions, in motion and tracking of a target.

Note that this invention is not strictly a robotics invention. Some sensors might be robots, especially if they are mobile. But other sensors might be fixed in location and not typically regarded as robots. A robot can be fixed in location, as many are in factories. But those robots are considered to be such because often they have mechanical tools under their control, or they have “limbs” that can be moved to grasp objects. SD's fixed sensors do not have those mechanical abilities, in the minimal implementation. (Cf. [Siciliano].)

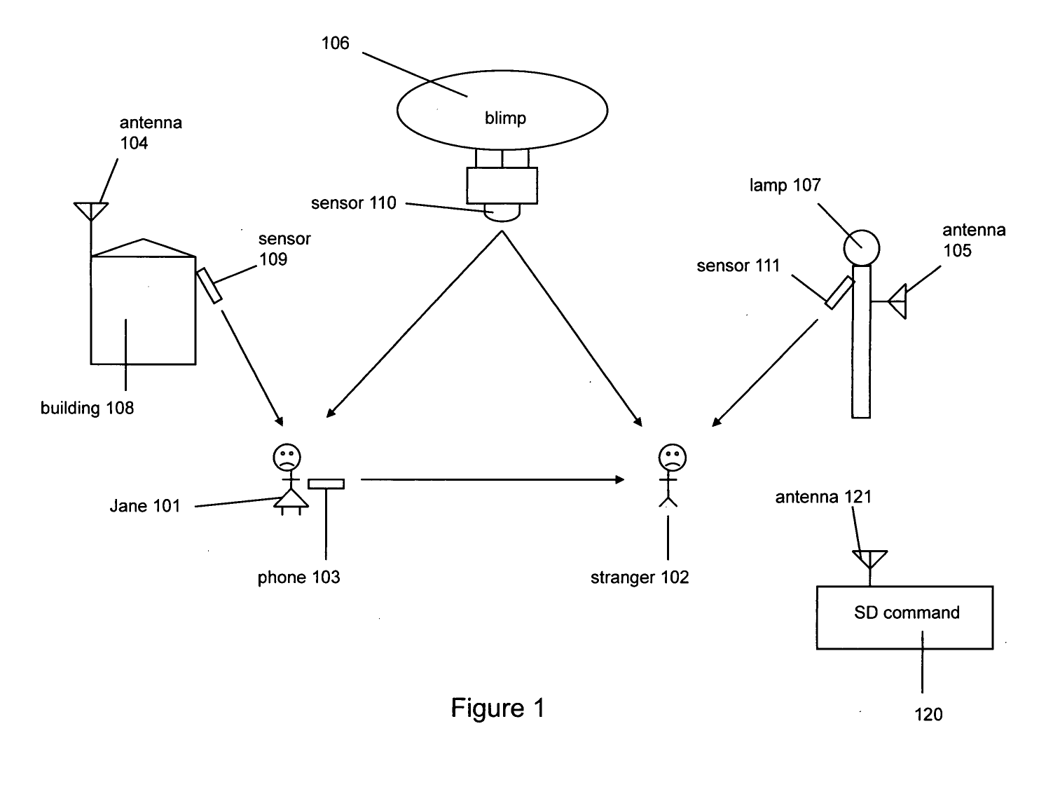

FIG. 1 show certain components of SD. Sensor 109 is attached to building 108, where the building is not considered part of SD. Sensor 111 is attached to lamp 107, where the lamp is not considered part of SD. Sensor 110 is attached to blimp 106. Depending on the implementation, the blimp might be considered part of SD or not. For example, if the blimp is solely used to carry sensor 110, then the blimp would be part of SD. While if the blimp is primarily used for another purpose, e.g. providing wireless internet service or advertising, then it might perhaps not be considered part of SD.

Note that sensor 109 could be in a fixed position on building 108, or it might be mobile along the building, on a track.

FIG. 1 shows antenna 104 and antenna 105. These are part of SD. Note that in this example, they are attached to the same structures that also have sensors that are part of SD. In general, this is coincidental. For example, a building might have only an antenna of SD, and no sensor of SD.

FIG. 1 shows SD command 120. This is the central command unit of SD. It is implicitly in contact with the other elements of SD. This includes via using antenna 121. SD command 120 exercises some degree of control over these elements. Different elements can have different amounts of autonomous control over their movements and other actions. SD command 120 communicates with the other elements via wireless (the usual case) and wired means. For simplicity in FIG. 1, no direct wired links are shown between command 120 and the other elements of SD. In general, SD might have several command units, though only one is shown in FIG. 1. Antenna 121 can represent several different antennas at SD command 120.

FIG. 1 for simplicity omits mobile sensors that move along the ground.

Optionally but preferably, SD via its sensors, database and internal logic, builds a three dimensional picture of the surroundings, or has this given to it as an input to this invention when it is initially deployed. The device knows of the street grid and the buildings along the streets, as well as any fixed obstacles, like trees, signposts and mailboxes. SD also uses knowledge of the time-varying effect of shadows in the images it collects. Here the time variation can be a deterministic function of the time of day and the day in the year (i.e. seasonal), as well as a stochastic function of the weather and clouds. Knowledge of these helps when tracking a person, in being able to more easily distinguish the person's shape from the surroundings, especially when the sensor is mobile.

Another advantage of SD knowing the fixed items in its environment is that it can know the locations and geometry of these to high accuracy. So, for example, if it has a sensor on a building wall, then its position can be easily known to perhaps higher accuracy than by only using standard GPS or assisted GPS methods. Other methods involve surveying or mapping methods, as described by [Yu]. Essentially, knowing a priori to high accuracy the positions of SD's fixed nodes lets SD use this knowledge to improve its knowledge of the time varying locations of its mobile nodes. (Cf. Chapter 11, “Anchor-based Localization for Wireless Sensor Networks” in [Yu].) The improved accuracy of knowing its sensor locations can in turn be used to improve the accuracy of the positions of those it is tracking.

SD might periodically rescan its environment, to detect changes to it that could be classified as static based on the time scale given by the duration of time for a person to walk past an instance of those locations. For example, a vacant retail site might now be occupied, and the new business changes the awnings and puts out illumination at night, where previously the site was dark. Hence the shadows and lighting around the site could be different in both day and night.

There has been substantial work in the area of capturing a three dimensional model of an urban region. See for example, “Apparatus and method for creating a virtual three-dimensional environment, and method for generating revenue therefrom” by [Edecker] and references therein. Our invention provides a context for the usage of [Edecker] and similar inventions.

The chapter titled “Vision Based Person Tracking and Following in Unstructured Environments” in [Billingsly] describes a harder, more general case where the mobile sensor robot has no a priori knowledge of the background around the person being tracked. When the person moves, his image is combined with that of the new (i.e. unknown to the sensor) background. In contrast, in this invention the device can pre-record images and any germane associated data of the surroundings when it is initially deployed. Using this greatly aids the signal discrimination when it is tracking a person against the background images of those surroundings.

A cellphone can make wireless contact with SD. This might be done via the normal cellphone radio, or perhaps via other wireless techniques like Bluetooth, Jini, WiFi, WiMax or Zigbee. Preferably, SD should at least be able to support cellphone radio; hence it preferably has a phone number. SD might support as many of the other wireless protocols as possible. This would also include any protocols not currently in existence. SD could have several of these wireless transceivers situated throughout the region that it covers.

The components of SD that do these wireless communications are not considered to be sensors, as the data they collect are not used to form images, but are messages going to and from SD.

Thus SD has two types of coverage regions. An image coverage region is those areas currently directly under the image coverage of its sensors. Here we define “currently” to include the line of sight areas within the panning range of a sensor, though not possibly in the instantaneous view of the sensor. SD also has a communications coverage region. In general, this is not restricted to line of sight from SD's transceivers, as most communications protocols are not line of sight.

FIG. 1 shows Jane 101 with cellphone 103. Suppose Jane walks within wireless range of SD, where this refers to a wireless protocol like those previously mentioned, and where her cellphone and SD support that given protocol. She might be meeting a person nearby that she does not know. Or she might see a stranger 102 approaching. She does not definitely suspect the person of bad intent. So she has [yet] no probable cause to call authorities via her phone. What this invention offers is an intermediate alternative that can enhance her safety. In part, this is because of the possibility that by the time she has probable cause, she might not be able to do the conventional alerting.

The wireless communication with an SD transceiver might include instructions or tips from SD for a minimum transmission power by the phone, adequate enough so that future signals from the phone via that particular protocol can be received by SD. Akin to how a cellphone making contact with its basestation often has logic, perhaps aided by information from the basestation, about minimising its transmission power. That is, when the cellphone is close to the basestation, it can transmit at lower power. In this invention, the minimization could differ from the latter for two reasons. The first reason is that SD could have several transceivers, whereas a cell has only one basestation. So determining the minimum power might involve different details of geometry. The second reason is that the frequency ranges for communication between the phone and SD will, in general, be different from those of normal cellphone usage. So the physics of transmission through air, and multipath reflections might differ.

There could be dual use transceivers. For example, a shop might have a Bluetooth transceiver, so that a passerby could use her cellphone, if it has Bluetooth capability, to find out information about the shop's items. There might be an option in this interaction so that messages could be relayed to and from SD.

We assume that Jane has a cellphone with GPS [or assisted GPS] and accelerometers and a compass. The phone tells SD its location, velocity and orientation.

One possibility is that Jane is within wireless range of SD, but outside the current range of its imaging sensors. In this case, if one or more of the sensors are mobile, SD might return an estimate to her phone of whether it can move those sensors to cover her, and if so, how long this will take, assuming she stays in her current location. SD might give directions so that she can move to within coverage based on the current locations of the sensors, whether the sensors are fixed or mobile. If some are mobile, then it might devise moving those in trajectories and likewise offer directions to her, to minimise the distance that she can traverse to come within coverage.

If SD sends directions to her, for her to move to bring herself under visual coverage, then these directions could be in various forms. A map of the street grid, with the trajectory drawn on it; where this map is then displayed on her phone. Or as audio instructions, which are then read out by her phone. Or as text directions, which are displayed as text on the phone. Or some combination of these. If she is using a head mounted display or some type of augmented reality system, then the directions might be overlaid on her vision.

When Jane is under direct visual coverage of SD, this could be by several sensors.

We emphasise that Jane requests direct surveillance of her and her immediate surroundings, as she walks through a region. There should be no issue of the right of privacy, because this is done in a publicly accessible region.

There has been substantial previous work about coordinating or informing a person, who has a communications device that knows its location, about when another device will be brought to that location. See for example [Horstemeyer] and references therein. Note however that most cited instances in that invention refer to cases like the person wanting to know when a bus will arrive, or when a truck with a package will arrive at her location. In our invention, one difference is that no package is being delivered or taken from Jane. Another is that when the “vehicle” (sensor) arrives at her location, it might then follow her.

SD might have sensors that are dormant; i.e. in a low power, non-data gathering mode. Jane's message to SD might cause it to turn these on and possibly to move them towards her, if they are mobile. Based on Jane's location, SD might only activate those dormant sensors close to her.

SD could know of other devices of similar functionality in its neighbourhood. The coverage regions of those devices might be near or overlap with those of SD. If Jane is outside the coverage of SD, it might tell her if she is in the coverage of other devices, or the probable directions to go to get within coverage. We say probable because other devices might have mobile sensors, and SD might not know the current locations or even any locations of those other devices' sensors. The latter situation might be where a device only broadcasts a general sensor coverage region that it supports.

SD might communicate with a neighbouring instance of another SD, so that the latter could move its sensors so as to bring them optimally into coverage of Jane, based on her trajectory. If Jane has a history of walking along a given route, then knowledge of the route could be used by both SDs, to optimize their coverages of her. This could be considered a handoff protocol. Part of this protocol could involve the first SD passing along any data it has that is associated with Jane. For example, this could include images and trajectory of a stranger that Jane had earlier pointed to with her phone. (This is discussed in more detail below.) So the second SD could track this person if he also enters with its coverage.

There is no requirement that the different SDs are owned or run by the same company. But it is mutually beneficial that a message protocol exists so that the devices can exchange data as described by this invention.

Optionally but preferably, Jane's phone can tell SD the orientation of the phone, as found from the phone's compass. So when Jane contacts SD, she can point the phone in the direction of the other person [the suspect]. Knowing Jane's location and the orientation, SD can draw a vector. By extending this vector until it intersects an object, preferably of human shape, or possibly of a vehicle, then the device can “tag” that object in its memory, and have logic that lets its cameras follow that person or vehicle.

The pointing of the phone towards a stranger could be done in different ways, for different phones. For example, a given phone might define the pointing as being done via orienting an embedded camera, as though Jane were to take a photo of the stranger. Another phone might define pointing in this context to be as though the phone were pointed using an embedded Bluetooth transmitter or some other line of sight transmitter that the phone might have. This reuses Jane's habit of pointing her phone in that context. Another phone might simply define pointing in the context of this invention as pointing the phone along its long axis, where in general this could be different from the two other definitions, for that phone.

The definition of the choice of pointing could be also a parameter that is sent from the phone to SD. The values of this parameter are predefined. The intent is that enough information is given to SD from the phone, using the phone's compass reading and other orientation data, so that SD can infer a pointing vector.

Pointing could also be done if Jane is using/wearing an augmented reality device (ARD). Such a device typically uses its position and orientation in tandem with remote databases to overlay on Jane's vision graphical artifacts (“markup”) associated with physical objects in that vision. The device might be used in conjunction with Jane's cellphone, or perhaps it might also have some or all of the functionality of a typical cellphone. We assume that the ARD has some means for Jane to pick or indicate a certain object or direction in an image. This ability could be considered the analog of when you have a browser that shows a web page, you can move a mouse onto a clickable link, and pick that link. In the context of the ARD, this ability might be considered a basic feature. For example, if Jane picks a building, the ARD would wirelessly communicate with some server to pull up extra data about the building, to be shown in Jane's vision. The picking can be repurposed in the context of this invention to let Jane point to a person or object, like a car, and have this communicated to the SD.

Another method for pointing at a stranger is via haptic devices that Jane might have, like special gloves or jacket.

ARD also allows a feedback mechanism for SD to indicate to Jane which person or object it will track, based on Jane's picking. SD can return a periodic data feed to the ARD, indicating the location of what it is tracking. ARD can map this into indicating on Jane's vision the tracked object. This uses the location of the object given by SD, and the location and orientation of ARD. ARD has enough information to at least indicate a vector in the vision, or a specific object.

Suppose while Jane means to hold the phone in a given direction, her hold wavers during the time in which SD obtains the phone's orientation. Or, even if the phone were effectively stationary during this acquisition time, Jane's aim might be off by a few degrees. Hence SD could use heuristics to, for example, extend the vector, or a cone, and find the closest person within that cone, or, failing that, the closest person outside that cone. There might be a tradeoff. For example, suppose within the cone, there is a vehicle and a person (not in the vehicle) at the same distance from Jane. SD might preferably image and track the person. But if SD has enough imaging and computational resources, it might track both. In another example, suppose a vector is used, and it points to a vehicle 30 meters away from Jane. But within 5 degrees of that vector is a person, who is 15 meters away. SD could interpret this, based on various thresholds, as meaning that Jane intended to point to the stranger. So, for example, if a vector is used, this could be effectively broadened to a cone subtending some angle, so as to account for inaccuracies in Jane's pointing.

The amount of broadening of a vector could use biometric information about Jane, if it is available and germane. For example, suppose Jane has some neurological condition that causes her hand to quiver, and that her cellphone has biometric sensors that know this, or that, in some other manner, Jane's condition is conveyed to the phone, as an a priori condition. Then even if the holding of the phone in a given direction can be read quickly enough to give a vector, the phone can broadcast this to SD with a suggestion to use an uncertainty in that orientation, where the amount of angular uncertainty (aka. the angular span of the cone) could be a function of the severity of Jane's condition.

Here, the cone has its apex being the location of the phone. But SD may use a truncated cone. This corresponds to SD having some uncertainty about the phone's location. The uncertainty can be due to the geometry of the positions of SD's sensors which can image Jane's phone, and the resolving power of the sensors, as well as the phone being occluded by another object, which could be Jane.

If the object pointed to is recognised as a vehicle, SD can have logic to detect and track any persons that come from the vehicle. Here, “Occupant Sensing System” by [Breed] might be applied to classify any occupants of the vehicle.

Likewise if the object is a building, then SD might track any persons coming from there towards Jane.

This assumes that when Jane pointed her phone, as she contacted SD, she was already in image coverage by SD. If not, SD might reply thus. Then, assuming that SD manages to bring her within image coverage of its sensors, or that she has moved into such coverage, it can indicate thus, and at this point, Jane can repoint her phone at a person, vehicle or building, if this is still relevant.

For simplicity in the narrative, we shall assume that there is only one other person. If there are several, then if Jane's phone points to a group, SD can use image recognition to count and track all the members, to the best of its ability.

At a future time, when Jane is assumed to be in image coverage, she can repeat the above steps to point to another stranger for SD to track. SD might impose some limit on the maximum number of strangers it will track for her.

Instead of pointing her phone, when Jane first contacts SD, she might indicate that SD should instead surveil her and anyone entering within some distance around her. This distance could be taken by SD and adjusted, depending on the crowd density and the standard deviation of the fluctuations in this density. So if Jane asks for surveillance for persons closing within 8 meters of her, and the average inter-person separation in the crowd is 5 meters, SD might override that 8 m and, say, lower it to 1 m. At a later time, if the crowd density falls, so that the inter-person separation increases, SD might increase that minimum distance around Jane. Here, the example 8 m might be a default setting already on Jane's phone, for simplicity and speed in contacting SD.

Another action possible is where Jane furnishes SD with a description of the person. He is not yet in view of her. She might have had some earlier acquaintance with him, in person or electronically. The description given to SD might be images or a textual description. SD is instructed to surveil for a person meeting that description, if he enters within visual coverage of SD. This action by SD can be instead of or in addition to the steps of the previous paragraph.

This invention assumes lower level methods exist for image recognition. There has been much research in the latter field. Often this has been posed as a situation where a given object has to be recognized and tracked as it moves. But why that object was chosen to be recognized was usually outside the scope of the methods. Our invention allows for the modular selection of any one of these methods, or possibly the use of several, to optimize recognition.

SD can have image templates with typical shapes of a person, and objects like a car, truck, motorcycle, bicycle or wheelchair, that might contain a person. These could be used by lower level recognition routines. Likewise, SD could have code that takes a two dimensional image (photo) of a person, and can extrapolate this to a three dimensional object that it should be looking for. This uses methods developed in computer animation, to map from a photo of a person to an overlay of a three dimensional model of that person.

SD could also have code that takes a written description (e.g. “1.8 meters tall, 80-90 kilos, blond, clean shaven”) and tries to match these against persons it images. This could include heuristics about which parameters can be altered, and the manners of these alterations. For example, a height can be altered upwards by a person using platform shoes, but it is difficult to envision the height altered downwards. Likewise a weight can be a lower bound, since a person in question is unlikely to have lost significant weight.

An extension is where Jane asks SD to track people around her, as she moves, and to detect any persons that might be following her. SD can use various heuristics to try to detect any such persons. A utility here is that through its various sensors, SD can apply such methods to people who might not be in line of sight of Jane. Hence, these could be used against a group of people following Jane, where individuals periodically go into line of sight and then drop out. SD effectively acts as a counter surveillance network for Jane.

Suppose SD has found several possible persons that might be following Jane. It can tell her in various ways. One way is to send email. SD is assumed to have Internet access and a web server and an email address. This email can have images of the suspects, taken by SD's sensors. The email can be formatted in HTML or some other markup language that is likely to be able to be displayed on Jane's phone. In just one possible manner, the images in the email might have associated buttons or menu options. These could have meanings like {“I don't recognise this person”, “I recognise this person”, “get a better image”, “alert authorities”}. When Jane makes a choice, it goes to SD's web server. So if Jane says she does not recognise a person, SD could choose not to track that person, which simplifies its tasks. If Jane says she does recognise a person or “get a better image” then SD might direct more sensors to track or focus more closely or perform more image analysis on the person. In general, SD could be constrained in both the number of sensors it can dedicate to Jane, and the level of computational effort it can apply to image analysis. So the feedback from Jane is important in helping SD make better informed choices.

SD might communicate directly with Jane via some wireless-protocol, under which Jane is in SD's wireless coverage. This can be done if the channel has enough bandwidth for SD to transmit images of suspects to Jane's phone. If this is possible, it may have an advantage over using the Internet and email in being more direct. The latter depends in part on the responsiveness of Jane's mail server and of the Internet routers between SD and the mail server and between Jane's phone and SD's web server. If SD can communicate directly, then this could be quicker and more reliable. The data it sends to Jane might be essentially formatted in a way similar to the previous paragraph, where Jane can assess what SD has found.

If Jane wears an augmented reality device that can also show rendered images as well as vector images, then when SD sends a message to Jane with images of suspects, these images might be shown on the ARD.

For both cases of Jane using a phone or an ARD, SD can also return data showing the current locations and possibly vectors of suspects, or even all persons within some region around Jane. Importantly, this region includes subregions that are not in her line of sight. This map could be shown in near real time mode; e.g. SD sends Jane a new map every 2 seconds.

A utility of our invention is that through the cooperative behaviour of multiple sensors, it can allow for the improved efficacy of lower level image recognition methods.

Another utility of our invention is that it gives both a reason why an object is chosen to be tracked AND how this object is picked. These are two different issues. A problem that appears to be rarely noticed in the state of the art is that existing (lower level) methods of image recognition conflate these issues. A given latter method might often have the experimenter define or pick an object to be tracked, at the start of the experiment, which obscures the distinction between the issues, because both issues are preset at the start, and so never arise during the unfolding of the experiment.

If the object is Jane, the reason she is to be tracked is that she requested it, for her own protection. How she is picked is via her cellphone communication to SD.

If the object is a stranger (that interacts with Jane), then the reason he is tracked is because Jane requested it. A way this object is picked is via the pointing of Jane's cellphone towards him, when she contacts SD. Lacking this, another way is via SD detecting him when he gets close to Jane.

Another utility of our invention follows from the previous utility. In the state of the art, the choosing of an object to track was done manually by the experimenter. So there was a need for a human to control the experiment (deus ex machina). In this invention, a human (Jane) still does the picking. But Jane is inside the experiment (i.e. invention). There is no need for a human to control SD to tell it to pick an object, which is a crucial point of automation. Hence an advantage of this invention is that the command decision has been refactored from a boundary condition to an internal event. Which makes our invention more modular (or automated) compared to the state of the art.

All images or data feeds taken by SD could have associated data like timestamps and locations.

But why doesn't Jane simply use the camera on her cellphone to take a photo of the other person? There are several reasons why the device's cameras are useful:

1. While increasingly many cellphones have cameras, phones are being sold with a range of abilities, and it cannot be assumed that every phone will have a camera. And in the general case where Jane's wireless device is not a cellphone, then there might be even less chance that it does not have a camera.
2. The camera on a cellphone [if it has one] has limited resolution. The most important reason for this is the size of the lens, which is the ultimate limit on the resolving ability of any optical system. (Cf. [Hecht].) The small size of the phone places an upper limit on the maximum size of an enclosed camera. SD's cameras have no such restriction. A cellphone's camera is best suited for taking a photo of an object only a few meters away. SD can take photos of someone much further away. This can be useful both in tracking and recording him when he approaches Jane and when he moves away from her.
3. Some of SD's cameras might be able to take images outside the visible spectrum. Perhaps in the infrared. This can be convenient at night, when the person is in shadow or darkness [at least in the visible spectrum]. Another case is if a camera [or cameras] can take Ultra Wideband images. (Cf. [Aiello]). The penetrating power at these short wavelengths can be used to [or to try to] detect if the person is carrying various metallic objects. If so, then image recognition can then be run on those images, to see if any are in the shape of firearms, for example. If any are detected, the device can trigger alarms.
4. The images taken by SD are not stored on Jane's phone. Suppose Jane takes photos of the person. In general these reside only on her phone. It is typically a separate manual step, or steps, to upload these to her phone carrier's server. Thus if she does not upload, then if the person were to damage or take her phone, the images on it would not be available to others.
5. For Jane to take a photo of the person might be dangerous to her. Often, an alert person can tell if someone nearby is taking a photo of him. For example, the phone might issue a click or flash. And Jane needs to be pointing the lens at him. If he is not [yet] overtly hostile, her actions might trigger this.

Note in this context that above we said Jane might point her phone at the stranger, to tell SD to track him. This could be done with her phone in a bag or inside a coat pocket, for example. So the stranger does not see an overt action by her with the phone.

6. SD might be able to take video, not just a few static images. While a cellphone might be able to take video, this is generally a rarer ability. The recording of video by SD can give more information about the person, like a distinctive gait.

7. SD might have cameras that can take images of the person from different angles. This can include having logic that looks to see if the person came from the direction or from a larger rectangular object, i.e. a vehicle; and when the person leaves Jane, if he goes in the direction of such an object, or into such an object. (Cf. [Davies], [Nixon].) In this case, SD can have logic to have its cameras pan for the license plate of the vehicle and to extract the license via Optical Character Recognition. (Cf. [Mori].)

If the license can be extracted, SD can query a police computer to see if it corresponds to a stolen vehicle. If so, then alarms can be sent to the police and to Jane's phone.

Vehicle analysis can be expanded upon if the vehicle answers wireless queries.

That is, the vehicle provides information about itself in response to certain types of wireless queries. This might be publicly available information; i.e. given out to any questioner. Or, suppose that if certain queries are made by authoritative questioners, then the vehicle will give out extra, non-public information. If there is a means by which the vehicle can verify in a wireless manner that a questioner is authoritative, and if the device can pass such a test, then the device can make such queries, to extract more information.

Of course, the stranger could have modified his vehicle to not wirelessly reveal such information, or to give out false information. But the technical barrier to this might mean that it is still useful to interrogate the vehicle.

8. Related to the previous reason, if SD's cameras can be moved [i.e. not just panned and zoomed], then to the extent possible, these might be moved to optimise the capturing of images of the person.

In addition to the above reasons, SD might have directional microphones that can be focused on Jane and on the person. As with Jane having a phone that can take images, she might also be able to use her phone or another gadget on her person, to record the conversation between her and the person, if he has a conversation with her. But this conversation might only be stored on her phone, whereas SD stores it elsewhere, where the person cannot get to it.

The ability to record the stranger's voice can help to identify him. Also, the ability to record the conversation can give important information not revealed by any images or video. The conversation can give context to any recorded actions.

The detected audio can be analysed by an Automatic Speech Recogniser (ASR) inside SD. Various ASRs are now commonly available, and typically use Hidden Markov Models. It is not expected that an implementation of this invention develop its own ASR. Preferably, it would license an ASR from existing ASR providers like IBM Corp. or Nuance Corp.

The audio can be analysed for such facets as volume. If the volume of audio from Jane or the stranger is considered “too high”, then this could be used by SD as an alarm indicator; e.g. one of them is screaming. This can be used even if the ASR cannot detect any words in that audio. Another action is possible if the ASR is capable of detecting stress in one or both person's audio. This could be used as an alarm indicator, though perhaps at a lesser level than the previous case, if alarm indicators are mapped to a numerical range, where a greater value indicates a greater chance of an alarm. If the ASR can detect actual words in the conversation, then SD can match these against a list of words or phrases that suggest a danger to Jane. If enough matches (where enough is defined by some heuristic threshold) are found, then SD can trigger an alarm.

The use of a microphone to record speech may be restricted in some countries or subregions of countries. For example, in the United States, automatic recording of speech in a public area might be prohibited by anti-wiretapping statutes. However, individuals can generally record conversations in which they are taking part. So if Jane were to instruct SD to record any conversations she is involved in, this may be permitted. In general, legislative or judicial permissions for SD to record audio is outside the scope of this invention. If this action is prohibited, then the relevant paragraphs above can be omitted in any implementation of SD within a given region.

A variant on the above is where Jane initially contacts SD, and it records and tracks her, but the phone does not point at another person. An important reason might be that Jane is blind. SD can record if she interacts with someone else, and if so, track that person to the limits of its camera range.

When Jane points her phone at another person, or when, as in the previous paragraph, she interacts with someone, SD can have logic that can focus on the person's face. It can then take that image and communicate it to some other entity that possibly has a set of suspects' faces. Currently, image comparison between a given human face and another set of faces is subject to much research. But to the extent that it can be done, SD can use this via the assistance of another external machine that does facial analysis.

In a related way, consider when Jane walks. SD could track those around her, especially those walking in the same general direction. Depending on the resolutions and positioning of its sensors, it could try to take images of these persons. Then it might transmit these to an external database of suspects.

Note that the device of this invention has, in this respect, a far simpler image recognition task. It has to find a human object and optimise an image of the face.

If that external machine finds a match between the image/s given to it by the device and a person in its database of suspects, then that external machine could inform authorities and SD. SD could also inform Jane via wireless contact to her phone. Also, it might activate various visible and audible alarms in her vicinity, for her protection.

A variant is where the external machine is given Jane's phone number, and it directly contacts her via that number.

Suppose it is desired to track the person, as he leaves the range of SD's sensors. There could be a standardised protocol of a message that SD passes to similar devices in the general vicinity. The message might include several images of the person, and of the person's vehicle and license, if applicable.

What are the reasons to track the person?

The first would be if a match was found between that person and an entry in a list of suspects, as described above.

The second reason would be if Jane, during her interactions, presses another alert to SD. This indicates that she definitely requires assistance; she now considers the person dangerous.

The third reason could be if Jane and the person are observed by SD to get close, he then leaves, and SD then contacts her and she does not reply. In this case, aside from tracking the person, the device might also alert authorities to come to Jane's location. Note that the image recognition logic to deduce that Jane and the person are getting closer, and then the person leaving is straightforward. Largely, it is a question of gross feature recognition of large objects.

A fourth reason could be if Jane and the person are observed leaving together, and SD sends a message to her phone and she does not reply, perhaps because she is under duress.

In the above, it was assumed that Jane is meeting someone. This can be extended to where Jane is walking through some neighbourhood and she asks SD for an escort. SD's sensor coverage, including the important case where it has mobile sensors that can follow her, might be extensive enough that it can do this.

Assuming she is under coverage as she walks, then her phone can periodically query SD to see if she is still under coverage. Suppose she is out of coverage, or, more usefully, based on her velocity, SD estimates that she is in coverage but will soon be out of coverage. SD can convey this to her phone, which can alert her. This alert could include autogenerated advice from SD about what changes she can make in her trajectory to remain in coverage. For the case where SD has a mobile sensor tracking her, the simplest advice might be to stop walking and wait for the sensor to catch up with her.

The alert could also say that Jane will be moving entirely out of SD's region.

Whether Jane is standing or moving, and whether she is by herself or meets others, SD can use the images it has of her initially and periodic polling of her phone to help track her. Here the polling can be equivalently met by the phone periodically contacting SD with its location. The aid to tracking is mostly useful when Jane is moving. If Jane is moving amongst other people, the pattern recognition problem [Billingsly] might be nontrivial, depending on such factors as her clothing and how this and her general shape differ from those of others nearby.

Also, with the phone acting as a beacon, if it moves considerably away from a shape that SD knows with reasonable confidence corresponds to Jane, then this could be a trigger that something untoward has happened.

If the phone acts as a beacon, by periodically broadcasting some id, there is a danger that an adversary might use this to electronically track Jane, where here the adversary does not need a human physical presence near her, who might be detected by SD. To protect against this, SD might transmit a seed to Jane's phone. This is a seed to an algorithm that will periodically make a pseudorandom number that the phone will broadcast. The assumption is that SD and the phone a priori know this algorithm. The seed can be transmitted to the phone via encryption, like perhaps a PKI encryption that uses a public key associated with the phone. So an evesdropping adversary will not be able to detect that beacon.

Computing the beacon might be briefly put a high load on the phone's microprocessor, which might be multitasking. If other tasks are very intensive (e.g. video), then computing the beacon could be defined as higher priority.

Under this scenario, when Jane is almost out of range of SD, whose sensors will not follow her any longer, then SD can contact her phone with this information. So the phone can turn off the beacon.

Another danger to guard against is when Jane's phone initially contacts SD. What if an adversary has emplaced a transceiver in SD's region that pretends to be SD? This can be guarded against by having an authoritative server accessible via the cellphone network. The server has a list of known SDs, along with their approximate locations (perhaps recorded as geofences that demarcate the region supported by each SD), and with their public keys. For example, if this invention is implemented in the United States, there might be a US government domain safetydevice.gov, while in China the analogous domain could be safetydevice.gov.cn. We deliberately use the choices of a government domain because the top level government domains (.gov and .gov.cn in these instances) might be run to stricter standards than a “generic” dot com or dot org. This is useful in increasing the trust that users have in the validity of this example domain.

The domain might have an Application Programming Interface that uses XML in its input queries and returns an XML formatted reply. For example, Jane's phone could send a query to that domain, that might in its simplest form say

| | |
|---|---|
| <ask> | |
| <lat> . . . </lat> | <!-- latitude of phone --> |
| <long>. . . </long> | <!-- longitude of phone --> |
| </ask> | |

The domain could reply with information about the closest SD, like

| | |
|---|---|
| <sd> | |
| <lat> . . . </lat> | <!-- latitude of SD --> |
| <long>. . . </long> | <!-- longitude of SD --> |
| <public>AD81 . . . </public> | <!-- public key of SD --> |
| <proto>WIMAX</proto> | |
| <proto>WIFI</proto> | |
| </sd> | |

In the above reply, the domain tells the phone SD's public key, along with the latitude and longitude of SD, where the latter coordinates might be of SD's command post, if it is fixed. Or it might be of the centroid of the region that SD covers. The reply also could have the <proto> field, the value of which maps to codes that indicate the protocols that SD supports. Here, the two values WIMAX and WIFI represent numerical constants that mean that SD supports WiMax and WiFi. More generally, the reply might be of a set of SDs near the phone's location.

Obviously, far more elaborate ask and reply messages could be envisaged. The above is meant to be a minimal implementation. So the phone can encrypt a brief query in a protocol supported by SD, encrypted with the public key of the SD near the phone's current location, where the public key was found from asking the authoritative server.

If SD were to offer Jane directions, it might also coordinate this trajectory with that of another person seeking SD's advice. So they might thus be walking in the same general direction and in proximity (convoying). This could improve the safety of both persons.

Suppose Jane is under image coverage by SD as she is walking. Imagine she is moving in a direction that will take her out of coverage. SD can have logic to predict the likelihood of this. In part, this can use not just Jane's current trajectory, but the possible shape or constraint of the path that she is on. For example, suppose the path curves behind a building and that SD cannot cover there. Then SD can predict that based on Jane moving along the path, and not just her current velocity, it cannot continue to cover.

SD can communicate with Jane's phone, while she is still under image coverage. This might be a message warning her that if she proceeds, she will not be in coverage, perhaps along with estimates of time and distance along her path when this will be true. Hence if she proceeds, she has been adequately warned of the limitations of this invention. Optionally, SD's message might also give alternative paths that keep her under coverage.

Just as Jane can point to a person with her cellphone and indicate that he is to be tracked by SD, there can also be a means via that phone that she can tell SD to stop tracking any other persons, and also, perhaps as a separate instruction, to stop tracking her. Note that SD does not have to comply with these instructions. It could have rules that indicate whether or not to do so. For example, if such a command comes after SD has found that the stranger came from a car which is stolen, or if the stranger's image is in a suspects' database, then SD can continue to track the stranger.

In the above, it was assumed that Jane carries a wireless device. But suppose she does not. An alternate minimal implementation would be where she passes an observation post maintained by SD, and she presses a button on it, or otherwise equivalently indicates to SD that she requests protective surveillance and tracking. This post is under observation by SD. From which it can deduce Jane's image when she contacts it. Hence it can track her.

Earlier, we wrote about the usages when Jane has an ARD. Similar remarks can be made if Jane has a Brain-Computer Interface implant. Depending on its implementation, it might have have a wireless connection, either directly as part of its hardware, or perhaps via a connection to a cellphone or other device that has wireless ability. If it is used for vision assistance, then Jane may be able to train herself to use it to pass commands wirelessly to SD, for picking images and for other tasks equivalent to those for when she has an ARD.

### 2. Locking a Car

When Jane initially contacts SD, imagine she has a car nearby. Suppose the (physical) key to its locks can be overridden by a secret code, and the code can be wirelessly transmitted to the car. (Note that the physical key might be operated where it makes mechanical contact with a lock, or where it makes wireless contact.) After the code is sent, her key will not open any car door, and it will not activate the ignition. This assumes there is another code that will re-enable the key. A typical usage of the codes could be when Jane's phone can transmit these to the car. She might do this if her key is lost or stolen.

A variant is where the codes, or perhaps extra codes, let her via her phone unlock the car doors and turn on the ignition. Her phone is acting as a backup key.

In turn, SD can act as a backup to the phone. Jane's phone could transmit the codes, suitably encrypted, to SD, as well as sending the first code to the car. So if the stranger takes her key, he cannot access her car. This encryption could be via SD's public key, which SD broadcasts, and which the phone then uses with PKI to encrypt Jane's codes and transmit these to SD.

What if he takes her phone as well? One answer is that her phone is password protected, so that he cannot use it to access her car. If not, see the answer to the next question.

What if he forces her to reveal her phone's password? The simplest answer is that the more steps he has to take, the longer the time involved, and the greater the risk to him. The process of this invention thus increases Jane's protection.

Alternatively, there could be more technical countermeasures. These depend on more elaborate steps implemented by the car.

### 3. Companion

Thus far, we described SD as having its sensors track Jane and any strangers interacting with her. But an important special case is where SD provides a mobile robot that escorts Jane as she is walking. The visible presence can act as a deterrent to others.

This companion can be equipped with cameras and microphones that record the interaction of anyone approaching Jane. The cost of this service might be greater than that of SD providing distant sensors that track Jane. Also, SD's ability to provide the escort might be very limited, compared to its ability to distantly track numerous people. For the latter, the sensor electronics and optics may be able to multitask between scanning several people.

### 4. Use of a VANET

If a decision is made to track the person, and he leaves in a vehicle, then alerts could also be placed into a Vehicle Ad Hoc Network (VANET). A VANET is a special and important case of a Mobile Ad Hoc Network (MANET). The latter are well described in [Boukerche], which also covers VANETs. See also [Golle] and [Ghosh], which describe one possible type of VANET. Unlike a general MANET, a VANET has its nodes being vehicles that are moving and confined to a road grid. The biggest differences are that a VANET node has a transceiver and computer that are not power constrained (they takes power from a car battery).

If there are common implementations of VANETs that allow for the placing of a vehicle description and the subsequent searching/tracking of that vehicle via other vehicles, then these could be used to feed such a search query.

This can be in addition to the device alerting various surveillance cameras or sensors emplaced in roadways. Typically, one could expect such sensors to be along major roads or intersections. Whereas VANETs are inherently dynamic and can offer complementary coverage of more roads.

The data sent from SD to a VANET could include not just a description of the suspect's vehicle but of the suspect himself. A VANET might not be able to usefully determine a description of a vehicle's occupants. But if at some point the vehicle were to stop and an occupant leave, a VANET could pass the suspect's description onto another nearby instance (or instances) of a device implementing this invention.

This assumes that the VANET nodes (vehicles) have enough memory and bandwidth to accommodate and pass along to other VANET nodes the extra data implicit in the suspect's description, which could include actual images of the suspect. This should be reasonable given most expectations of VANET abilities.

Currently, we are not aware of any VANETs being widely deployed on the roads of any country. However, if any were to exist, the invention offers an important and socially beneficial use of those VANETs.

### 5. Disabling a Suspect's Car

One postulated feature of future vehicles has been the ability to remotely turn off the ignition, or to prevent it being turned on. For safety reasons, this might only (or preferably) be done when the car is static. Law enforcement might be able to do this, under some scenarios, by issuing a signal that is verified by the vehicle as a valid command. If this functionality were implemented, one extension could be that an SD could also have that ability. Here, this might occur according to various rules.

One such might be a chain of events observed by SD: Jane asked SD for coverage; a suspect approached her; he left her; her phone issued an alarm based on her biometrics; SD tracked the suspect to a vehicle=>SD disables the vehicle.

### 6. Electronic Agent

Thus far, we described Jane as manually initiating contact with SD. But she might have some type of electronic agent. This could be running in her wireless device or perhaps in another device on her person. The agent might make a decision, based on some logic or heuristics, to contact SD, and ask it to initiate the surveillance steps described earlier.

Here an assumption is that if the agent makes such a decision, it can wirelessly contact SD. If the agent is located not on her phone, then it either has the ability to directly contact SD, or it can relay a query to the phone, which then contacts SD.

What steps might the agent take, to decide to contact SD? Perhaps the agent can measure certain biometric data about Jane. If these suggest that Jane is tense (e.g. high pulse rate, sweating), then this might contribute to such a decision. Other contributors might be if the agent knows based on past knowledge of Jane's locations that she has never been to her current location before, or if she has had bad encounters in this district. So the agent has access to, or has recorded, a history of Jane's travels.

The agent might also have access to public data about the safety of certain areas. So an unsafe area would increase the odds that the agent will call SD for coverage. This data might be provided by SD, in response to a query from Jane's phone, initiated by the agent.

Hence the agent could relieve Jane of some of the burdens about when to seek some type of assistance.

### 7. Embedded Cellphone

In some places in the above, it was assumed that Jane's cellphone is carried by her. This is the typical case at this time of writing (2009). But we also include the case where the phone might be physically embedded in her. This greatly reduces the risk that it can be taken from her. It can be seen that most of the steps in the invention still apply.

### 8. Optimising Device Workload

It can be expected that if many people use SD's services at the same time, and if there are many others in the neighbourhood, then SD can face a complex computational problem. It has to rapidly decide how to best scan its sensors, and how to move any mobile sensors, to meet all the coverage demands.

One factor in the decision might be the ability of Jane to pay for SD's attention. SD might post a fixed price for its services, where this price could be for a certain duration of coverage. Or the price might vary, depending on the current workload, like the number of people currently wanting coverage. The price could also be a function of how difficult SD anticipates it will be to track Jane. The crowds around Jane and how easy it is to distinguish Jane from those people might be a factor in that estimate.

Suppose Jane regularly (e.g. at roughly the same time 5 days a week) traverses a given route in SD's region. She may be able to get a discount on SD's services, because knowing a priori her usage patterns might simplify SD's optimisation problem.

Another possibility is that people like Jane bid for SD's services, using various auction mechanisms.

Some people might be able to pay less, like pensioners, elderly and veterans. These people might have codes in their phones, which are transmitted to SD, and which SD can verify against some authoritative database, perhaps run by the government.

For all of the above, payment could be done by various electronic and wireless means. There are currently many different usages of cellphones throughout the world in wireless payment schemes. In a given country, this invention could be adapted to use specific schemes.

Another possibility involves bartering. Jane could have spare computational resources that she is willing to let SD use. This is akin to the SETI@home experiment, where users with personal computers on the Internet downloaded a screensaver that ran analysis when the computer was idle. In this invention, Jane has a computer wirelessly accessible by SD, which then downloads various tasks to it. The tasks may be unrelated to the computational effort SD expends on tracking Jane or strangers around her. From a redundancy standpoint, the tasks that SD sends to Jane's machine might preferably be related to tracking another pedestrian who seeks SD's aid, where that person is not located near Jane. This assumes that two unrelated pedestrians are unlikely to both be under attack at the same time.

### 9. Competing Safety Devices

Thus far, we assumed that SD is the only such device in the region that it covers. But there could be several devices in a given region. They could compete for Jane's business. Jane, either manually or via rules she established for her electronic agent, can pick a specific SD. A decision might be made based on one or more of the following reasons:
a. Cost of an SD's service.
b. How quickly an SD can cover her, if she is not already in the coverage of its sensors.
c. How extensively an SD can cover her. Imagine she is traversing the same route on several days. Her phone can tell this to various SDs in the region, and find their abilities to cover her route. Or perhaps she has a given route planned, that she has never taken before. Her phone tells this route to the SDs and asks them to bid on it.
d. The type of coverage by an SD. For example, suppose an SD only has optical sensors and it is nighttime. While another SD has optical and infrared sensors. Jane's phone might pick the latter because it offers safer coverage.
e. An SD's reputation. For example, there could be various websites where users of SDs give feedback. These websites could be used by Jane.

There is also a possibility that 2 or more SDs in a given region could cooperate, to jointly offer coverage of Jane. In part, this could be a function of their workloads. For example, a given SD could be too busy to cover Jane over her entire route, assuming that it knows that route, so it might enlist another SD with the capacity to cover part of the route.

### 10. Safety Kiosk

SD can offer an optional feature to Jane. In the territory spanned by SD, there could be various Safety Kiosks (SKs). An SK is usually for only one person at a time, though perhaps more could be accommodated in some SKs. It is a temporary shelter, affording some protection against assailants, or against the weather.

We cover two topics. The first is how SD makes a decision to use the SK, and the second is the use of the SK.

The decision could be initiated by Jane, if she contacts SD via her phone and picks this option offered by SD. Or consider when Jane originally pointed her phone at a stranger, and SD then took images of him and contacted other databases and found that, for example, he was wanted by the authorities. Then SD could decide to use SK, and SD contacts Jane with directions to the SK. Another possibility is where SD found an image of the stranger, and then found from its records that backtracking the stranger in SD's video records led to his car, which SD then finds from an external database is stolen.

Another possibility is where SD observed Jane and a stranger interacting, the stranger then leaves Jane, and from biometric data transmitted by her phone, she is in stress or injured, or where SD from its image recognition of Jane's state, deduces that she is injured. If she is still mobile, SD can transmit directions to the nearest SK to her; for protection in case the stranger returns.

Consider the use of the SK by SD. An SK could be multipurposed. We offer several examples, some which extend the use of existing structures in some cities.

For example, an SK could be an extension of an enclosure built around an Automated Teller Machine. Some banks have placed these enclosures around their ATMs, to give customers more protection and confidence when using them. Typically, you need a credit or debit card from some bank, and not necessarily the bank that operates the enclosure and ATM, to unlock and enter the enclosure. The enclosure might have plastic or glass covering. We have noticed through ad hoc observations that such enclosures are sometimes used by homeless people in winter, as shelters. Here, the homeless person either has a credit or debit card, or might have entered as another person exited.

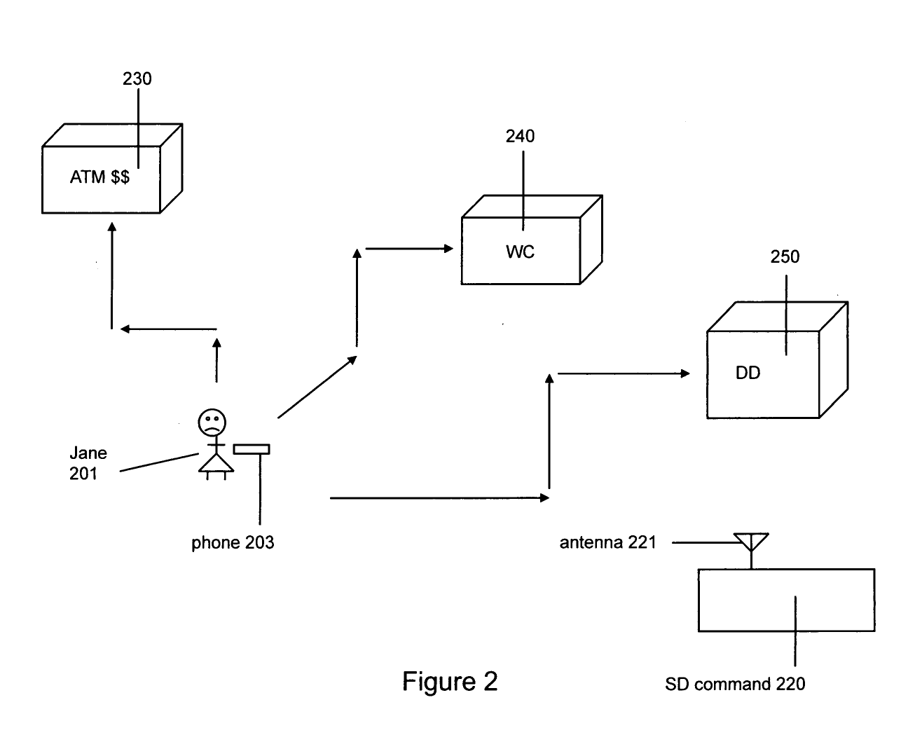

FIG. 2 shows a path from Jane 201 to ATM 230, as an example. Here, ATM 230 represents an enclosure for an ATM, as discussed in the previous paragraph. Implicitly in FIG. 2, the path was supplied to Jane 201 from SD command 220, via its antenna 221, which communicates with Jane's phone 203.

The enclosure could be extended into an SK with added electronics that lets SD communicate with it and do the following. When SD sends an open signal to the SK, the latter's door opens, so that Jane does not need to use a credit or debit card. After she enters, the door is automatically locked. A signal is sent to the authorities for help. And the door will not now open to another card. Optionally but preferably, SD will not now issue another open command based on a help request from another person. To prevent Jane's stranger from trying to persuade SD to open it via a bogus help request.

Granted, the enclosure might still be broken into by force, if its windows and door are not made of shatter-resistant material. But this does act as some degree of deterrent.

Or, if Jane needs emergency shelter from the winter, then SD and SK together give her access.

Another example involves the extension in usage of a standalone public toilet. Some are for single occupancy. (E.g. those made by JCDecaux Corp.) Typically, one might have to deposit a coin to open the door. Upon entry, the door closes and is locked. A toilet might already have an emergency button inside that the user can press to summon aid. The enclosure is solidly built and cannot easily be broken into. Currently, after some time interval, like 15 minutes, if the user has not exited, then the door is opened. This prevents someone monopolising the toilet for a protracted time. The extension is where it can communicate with SD. SD sends a signal to open the door, if no one is currently inside. Hence Jane can enter without a coin, which she might not have, or where she is in too much of a hurry to use. Then she can press the emergency button inside. Plus, SD could send an emergency signal, in case for example Jane is injured and does not or is unable to press the button. Also, SD instructs the toilet to now not open the door after that maximum time interval of normal use.

FIG. 2 shows a path from Jane 201 to WC 240 (“WC”=“water closet”). Implicitly in FIG. 2, the path was supplied to Jane 201 from SD command 220, via its antenna 221, which communicates with Jane's phone 203.

A third example is of an enclosure meant primarily to shelter against cold weather. These might be deployed in some cities to protect homeless during winter. If the enclosure has a door with electronics, then those could be adapted as per the previous examples so that the enclosure also acts as an SK.

A fourth example uses the double door entrances to some buildings. These are common in cities with cold winters. The double doors are used to minimise heat loss during winter (and possibly cold loss during summer). When the building is closed, the outer door is locked, and often so is the inner door. The space between the doors can usually fit a person and can be used as an SK when the building is closed. In this extension, both doors are locked after hours. If SD needs a nearby SK, it can contact this SK. SD sends a command to unlock the outer door. SK might have some means to verify the authenticity of this command; e.g. with SD's public key if it has one. SD then directs Jane into the SK. After she enters, assuming that SK or SD has some means to detect this, then preferably the outer door is closed and locked automatically, without requiring Jane to manually do this.

The latter assumes that the building is closed, and its SK is active. When the building is open, then Jane can simply enter fully into the building, to seek help.

FIG. 2 shows a path from Jane 201 to DD 250 (“DD”=“double doors”). Implicitly in FIG. 2, the path was supplied to Jane 201 from SD command 220, via its antenna 221, which communicates with Jane's phone 203.

These examples show that SK need not be owned by the owner of SD. They also show that SK can be made by straightforward modifications of the designs of existing structures. It may transpire that the economics of maintaining a standalone single purpose SK are prohibitive, given the cost of land and materials in an urban region. Hence a practical implementation of an SK may necessitate multipurposing a structure built primarily for another purpose. This is also plausible given that an SK would be used mostly for emergency reasons, and would be often vacant.

Why, in some of the examples, should the owner of the SK structure modify it so that it can function as an SK? In part, perhaps if SD derives income from offering its services, then part of this can be paid to the SK owner for its service. Or the local government might mandate that the structure also function as an SK, for improved public safety.

### 11. Powered Wheelchair

Suppose Jane is in a powered wheelchair, or some other “personal mobility device” (PMD). Currently, most or all such devices do not appear to have wireless ability. We describe here a PMD with such ability added, along with an interaction with SD.

We assume the PMD has GPS ability, along with accelerometers and a compass, so that it can find its location and orientation, much as Jane's cellphone was assumed to have similar ability. One variant on this is where the phone can be docked into the PMD, and the PMD derives such information from interrogating the phone.

Suppose the PMD can wirelessly contact SD. Then Jane can use this to have the SD download directions for a route that she can go in, for coverage by it, where Jane might furnish her destination. It is easy to extend this so that the downloaded directions can be directly executed by the PMD, instead of Jane having to see or hear these and then manually press the PMD controls to execute the directions. Here, there could be batch or continuous modes. Batch mode would be when SD downloads an entire trajectory in one transmission, and the PMD then executes it. Continuous mode is when incremental paths in the trajectory are downloaded at different times; e.g. when the PMD has done one path, then the next is downloaded. In both cases, there might be some override command that Jane can use to countermand any downloaded instructions.

Also, when the PMD is auto-executing instructions, there could preferably be sensors and associated logic to safely handle the crossing of streets and maneuvering between pedestrians.

The PMD might be able to measure some of Jane's biometrics, to monitor her health. If SD, in concert with the PMD, detects that Jane needs assistance, then it can download directions for the PMD to go to a location for assistance.

We can consider merging the description in the previous section about the use of an SK. So if for example Jane signals to the SD that she needs such a shelter, SD could take command of her PMD and drive it to the nearest available SK.

12. Comparison with [Laird]

In the prior art, [Laird] is the closest patent we have found to our invention. Because of this, we furnish here a detailed comparison. This requires many specific points of our invention, and thus we place it here, after the bulk of our invention has been defined, to make it easier for the reader.

The differences include the following.

a. The bulk of [Laird] concerns a wireless handset carried by a user. It can contact a “campus security management server”. The latter is the analog of our Safety Device. But Laird's server only has a conventional use of cameras, as in ‘the database can include information about nearby lighting fixtures and areas illuminated thereby (a “lighting map”), foliage, areas covered by surveillance cameras . . . .’ There is no novel usage of cameras by the campus server. In contrast, our invention describes at length how our SD can have multiple imaging sensors, and these can be mobile. Plus, our imaging sensors do image analysis on the images they collect. They do not just passively write images to storage, or display them on a screen for a human operator. Yet implicitly, when [Laird] does not describe how surveillance cameras are used, it can only be assumed that the state of the art is involved, namely the latter 2 operations.
b. Our sensors track Jane as she moves by, to the extent possible, keeping her and her surroundings under direct line of sight surveillance. This involves cooperative behaviour between the sensors, including a possible following by mobile sensors. In [Laird], the “tracking” of the pedestrian is not done via direct surveillance, but by a “network-assisted navigation server”. The latter's communication methods with the pedestrian's handset do not involve capturing images of the pedestrian. Note importantly that “track” and “tracking” have different meanings in [Laird] compared to this invention. In [Laird], the words refer to finding the pedestrian's location in terms of geographic coordinates, using data supplied by the phone. In our invention, the words refer to performing an image surveillance of Jane, and continuing this as Jane moves.
c. Speech recognition is used in [Laird] in the pedestrian's handset, as in the section “Handset Detection of an Emergency Call”, viz. “a speech recognition system can be used to monitor a voice call”, or by sensors attached to the person, as in the section “Wearable and Fixed Environmental Sensors”. In contrast, our SD can have directional microphones, and these can be part of the mobile sensors that follow Jane.

In passing, [Laird] does describe that some sensors can “be a fixed part of the campus infrastructure”. The examples cited by [Laird] do not include microphones with speech recognisers. But even if these were to be implicitly included in the campus infrastructure, they are in fixed locations.

d. [Laird] describes a usage where the handset is locked to the person, like a security bracelet. We have no such usage.
f. [Laird] describes the handset being used to take images and audio recordings and other possible biometric data, and the transmission of these to the server. But if the handset is damaged or stolen by an attacker, then the data might not be available. A key point about [Laird] is the emphasis on use of the handset. Our invention deliberately deprecates that. Our SD data collection is largely independent of the condition of Jane's phone.
g. Our SD lets Jane use her phone to point to a stranger. So SD can now track the stranger, including comparing his images to those of suspects. There is no analog to this in [Laird].
h. [Laird] appears to require that the user give a destination, when contacting the server, “the user specifies a destination location to the campus security management server”. We have no such requirement. An advantage is that this is easier for Jane. When she invokes her part in our invention, she simply has to contact SD. She might not have a destination in mind.
i. [Laird] has a case where when the user presses an emergency code on the handset, then the “handset requests nearby handsets to actively monitor and report information to the campus security management server”. This is far more restrictive than our invention. First, there might not be any other handsets nearby. Second, if there are, they might be general purpose cellphones, and there is no supposition that they would be able to “monitor and report information” in the manner described by [Laird]. Third, suppose that other handsets are nearby and they act as described by [Laird]. In general, they will not have visual coverage by their cameras of the first user and her immediate surroundings. Those handsets might be inside the clothing of their users, so they cannot take useful images or audio. And even otherwise, they do not have independent pan and zooming ability. So their users would have to manually point their handsets in the direction of the first user. If they sense that they are in danger, they might be more concerned with moving away than with surveilling the first user. Our invention has SD with a sensor array not subject to these restrictions.
j. Each “campus” in [Laird] is assumed to have only one server. In our Section 9, we describe how a region can have several SDs in it, that compete for business from users.
k. [Laird] does not describe cooperative behaviour from two servers that service adjoining areas, so as to provide continual protection to a person going between the areas.
l. [Laird] does not invoke the use of a VANET.
m. [Laird] does not use a Safety Kiosk. There is no analog in [Laird] of the campus server making an enclosure temporarily available to the user on an emergency basis.

### 13. Archiving Appointment Data

Thus far, this invention has largely been concerned about SD. Mostly, Jane's wireless device (cellphone) has had some minimal modifications primarily to contact SD and provide orientation information when Jane points it at a stranger. In this section, we describe more extensive changes on the phone. These changes are given in the context of a software agent running on the phone. However, what is an agent is somewhat subjective. So an alternate description would simply be of a program running on the phone.

Suppose Jane is meeting a stranger, Ralph, perhaps for a date, in some public place that can be surveilled by SD. They have made prior arrangements to meet at that particular place and time.

Suppose these were done by email, and Jane kept these messages; some are from Ralph and some might be copies of messages she sent to herself. Imagine Jane's email provider offers a calendar service. (The large email providers like Yahoo Inc., Hotmail Inc. and Google Inc do this, as a typical service.) So Jane makes a calendar entry for that place and time.

Imagine that the messaging service has integrated the calendar and messages in the following manner. When Jane defines a calendar entry, she can link existing messages to it. This could be unidirectional links from entry to messages. Conversely, when she is reading a specific message, there can be an option, perhaps accessed via a popup menu, or as a button in the framework of the page in which the message is shown, that lets her link the message to a calendar entry. This link might be unidirectional, from message to entry.

Then later, in a related way, when viewing a calendar entry, she can see unidirectional links that point to any associated messages. And when viewing a message, she can access a unidirectional link that points to an associated calendar entry. Or to several entries, if a message contains information about several upcoming events. Of course and in general, any arbitrary message need not have any calendar entry associated with it, and vice versa.

Suppose Jane makes a new calendar entry, and she links to several messages, going from entry to messages. As a convenience, the message provider might automatically make associations or links in the opposite direction, between those messages and the entry. So if she views one of those messages, a link has already been made between it and the entry. Here a unidirectional link is extended into a bidirectional link.

A simple extension is when Jane is looking at a list of messages, the list could indicate in some manner which messages are associated with calendar entries. She could pick a given message and see a second list, perhaps in a popup menu, of the message's associated calendar entries, and by picking an item in the latter list, she goes to a page for that calendar entry.

If the calendar can be viewed by others, perhaps in the group defined by Jane, then this might or might not also extend to them being able to view the links to the messages or the messages themselves. Jane could have a default policy, implemented by the message provider, that defaults to one of these choices. She can manually change the settings for given calendar entries, and where she can change the default.

There could also be ancillary support routines defined on the mail server so that if Jane has several messages linked to and from a calendar entry, and she deletes one of these messages, then when viewing the calendar entry, either the link to the gone message has automatically been removed, or it still exists, but is designated as a “dead” link. So that if it is picked, no message is shown; or the deleted message is shown, with a prompting or warning that it has been deleted. Likewise, imagine that a message has not been deleted, but that it is associated [linked to and from] a calendar entry, and the latter has been deleted. Then the GUI steps which Jane might use to see any calendar entry associated with the message will either show none, or show an entry with the warning that it has been deleted.

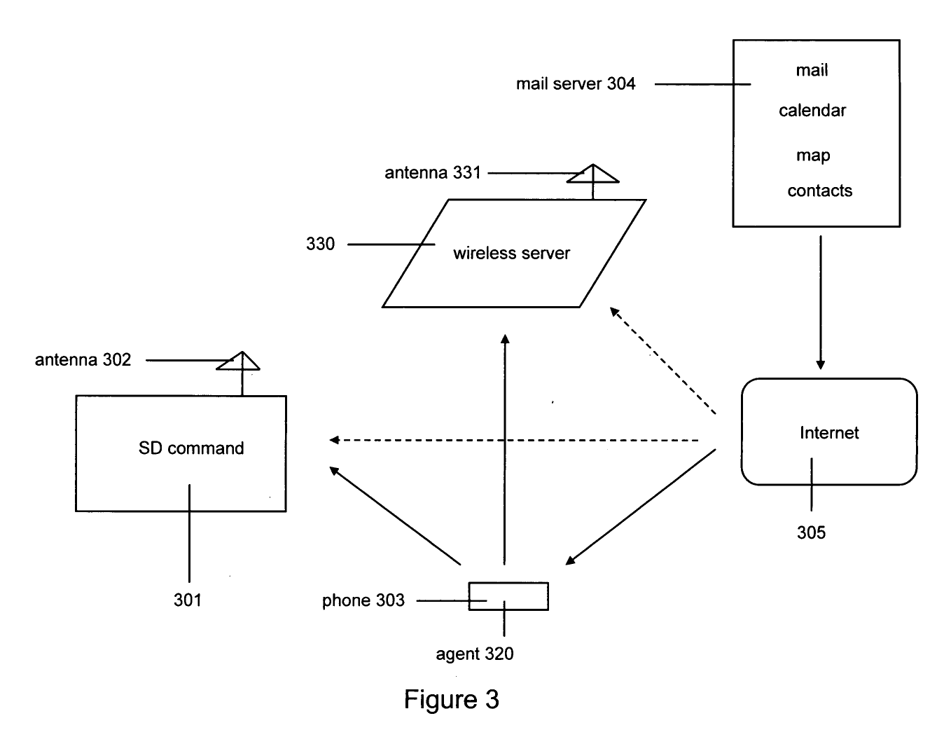

Now imagine that Jane's phone 303 in FIG. 3 has a smart agent 320, as suggested in Section 6. The agent is assumed to be able to access Jane's message account. (Jane has provided it with her password.) In general the message provider can be different from the wireless provider. In FIG. 3, her message account is shown on mail server 304. Agent 320 interacts with mail server 304 via Internet 305. Implicitly, the arrow connection between agent 320 and Internet 305 assumes a wireless connection between phone 303 and some wireless transceiver, possibly run by the phone's wireless provider.

The agent can apply various logic rules to download subsets of Jane's messages, and to access ancillary data stored in Jane's account, like her calendar. The agent can also access various data and functions of the phone, like the current time and location.

When Jane contacts SD with her phone, to surveil her, this can trigger the following actions by her agent. It logs into Jane's message account, and searches her calendar for upcoming appointments. In general, these will be timestamped by the message provider with its clock. The agent is assumed to be able to query the message provider for the current time. Then the agent can find the appointments for the next few hours. It might also look for appointments in the near past; e.g. what if Jane is running late for her date?

If the agent is not able to get the current time at the message provider, then it could get the time from the wireless provider, and then log into the message provider and use that time to search the calendar. In general, the 2 providers have different clocks, but as a practical matter, the clocks are not expected to differ by more than a few minutes, given the reliability of modern electronics and communications and the common custom of standardising on a temporal reference like Universal Time.

Suppose the agent finds one or more calendar entries on or around the current time. It copies these onto the memory of phone 303, along with any messages linked to these. The resultant data is then uploaded to SD command 301, using antenna 302, for safekeeping in case anything untoward happens to Jane. The data can also be retained on the phone, in a manner that can be easily recovered by forensic experts.

Note that the “macro” steps in the previous paragraph of all the data first being downloaded to the phone from the message provider, and then copied to SD, can be replaced by incremental steps, where “deltas” are downloaded to the phone and then uploaded to SD.

One extension is that the agent also copies the data to the wireless provider, on its wireless server 330 via antenna 331, who stores it as associated with Jane's wireless account. This could also be done exclusive-OR with the copying to SD.

An extension is where the agent can cause the copying of data from mail server 304 directly to a server run by SD command 301, where the server is assumed to be accessible via the Internet. This is indicated by the dashed arrow going from Internet 305 to SD command 301. The direct copying does not have to involve the use of antenna 302.

Likewise, another extension is where the agent can cause the copying of data from mail server 304 directly to the wireless server 330, where this is assumed to be connected to Internet 305.

The copying is indicated by the dashed arrow going from Internet 305 to wireless server 330. The direct copying does not have to involve the use of antenna 331.

An extension is where the agent parses other messages of Jane, looking for phrases that indicate an appointment on or around the current time.

An extension involves the case where Jane's message account also includes an address book, with definitions of friends or acquaintances. This might also be called “buddies” or “contacts” depending on the specific message provider. Jane defines addresses of persons she is in (regular) contact with, along with ancillary data about them. The agent can search the current appointments. If any have names or addresses in the address book, then those entries can also be downloaded to the phone.

An extension is where the agent uses the current location of Jane. Imagine that at the message provider, in addition to a calendar, it also lets Jane construct or annotate a map. The spatial analog of the calendar, where now Jane could record the locations of meetings. A map entry could have links to messages and calendar entries. The agent can find entries for the map for or around its current location, and download these to the phone.

An extension to the previous paragraph is where the agent parses other messages, looking for phrases that suggest an appointment at or around the current location.

The map and calendar functionalities might be combined. For example, in a map, at a given location that can be picked, a menu of options could exist. One option would be to show the messages associated with the location, as above. Another option brings up a calendar restricted to events at or near that location, where “near” could be quantified by some numeric value set by Jane, with a default provided by the mail server. An extension is where Jane could pick several locations on the map, and then a calendar is dynamically made, of all events associated with any of the picked locations.

In a map, if a location has a link to or from an existing message, and Jane deletes the message, then the mail server's software can automatically remove the link, or keep it. In the latter case, Jane picking it might cause the server to show the deleted message, along with a warning that it was deleted.

Another extension is where when Jane makes a calendar entry, she can also link to persons in her address book. The agent can find such links for the relevant calendar entries and download the associated person data to the phone.

In the above, we said the agent accesses Jane's account at the message provider. In general, there are at least two ways this can be done. The first is screen scraping. This is when the agent logs into Jane's account, and downloads various web pages, as though Jane herself were manually using her phone as a web browser to see her message account. Then, using prior knowledge of the markup structure of the downloaded pages, the agent extracts the germane data. This would often require that at some previous time, a programmer has coded the agent with information about the structure of the provider's pages. Also, for different message providers, separate instructions about parsing the different structures will be needed. The screen scraping approach has the advantage that it does not require the specific involvement of the message provider. It never knows that an agent is acting for Jane, instead of Jane herself. The disadvantage is that this is brittle; it depends on the structure of the pages. If the provider changes the pages, the parsing code will have to be changed.

The second method involves the active participation of the provider. It establishes an Application Programming Interface (API), such that a program like the agent can programmatically log into Jane's account, and query and extract data. Here, the queries would be with the intent of getting the types of data described above.

Thus the reader can see that the tasks of the agent in extracting the desired data are readily implementable.

In general, Jane might have accounts at several message providers. We assume that Jane has set up her agent with access to these, or at least to the relevant ones, as far as appointments are concerned.

It could be asked, if anything bad happens to Jane, surely investigators can easily get at her messages at her message provider? There are several difficulties with this. What message providers does she use, and what are her usernames at these? It can take hours or days for investigators to find this out. Then, how do they access her account if they do not know her passwords, and she is unavailable to give these? Court orders might be obtained, but this takes more time, and only works against providers in the same country as the court. This is harder than for investigators to find phone data associated with Jane's phone, like her SMS messages. There would usually be only one wireless provider or SD to deal with, and it is in the same jurisdiction as the court.

Hence it helps for any appointment data to be copied from the message provider. Copying to her phone helps, but not if the phone is damaged or stolen. So copying to SD or to the wireless provider provides two things. Secure storage. Fast access by investigators. Here, by prior arrangement between Jane and SD, and perhaps her wireless provider, messages stored at those entities in the context of this invention can be quickly accessed by investigators.

One variation on the above concerns the data that the agent copies from the message provider. For a calendar entry, Jane might also have provided links to various web pages; e.g. Ralph's blog, or to pages or blogs or messages written by him in newsgroups. The links are stored in data fields of the calendar entry, and in general will not have any of Jane's messages associated with them. The copying of the links by the agent might be not just of the links themselves, but of the pages addressed by these links. Likewise, Jane's messages that are linked to from the calendar entries might have URLs. The associated pages can also be copied.

Because suppose the pages are under the control of Ralph. After his encounter with Jane, he could remove or alter the pages, before investigators get to them. We do not anticipate any simple a priori way for the agent to deduce whether the pages are subject to this. So the most prudent and simplest action is to copy them. Or, instead of the agent doing the copy, it might just copy the addresses (URLs) and advise SD or the wireless provider to then do the actual copying of the pages. This has the advantage of reducing the bandwidth to and from the phone.

This assumes that Ralph has not already altered his pages prior to Jane contacting SD. One reason is that Jane might reread those pages just before meeting him, so he keeps them unchanged as long as possible.

Another advantage of the agent copying data to SD or to the wireless provider is that after Ralph meets Jane, he might be able to obtain by duress her passwords to her message providers. Then he can login to her accounts and erase any messages and calendar and map data.

This also implies that when the agent uploads data to SD or the wireless provider, they do not erase the data. Instead they retain the data for some fixed time. If the agent were to later upload more data, the newer data would not overwrite the earlier. It guards against the phone coming under Ralph's control after he meets Jane, and that the agent is also now under his control, so that he might try to erase any earlier data that was uploaded to SD or the wireless provider.

The method of this section has the utility that the steps performed by the agent largely do not involve complex methods of artificial intelligence. The tasks are mostly delineated by structures in the data (dates and locations) that the agent uses, and that Jane has previously applied or created. The only difficult tasks are the parsing of messages, looking for phrases that suggest meetings near Jane's current location or time. These are subject to the vagaries of unstructured written syntax. Hence the latter tasks could be subject to a time limit, to keep them bounded.

We claim:

1. A use of a Safety Device (SD) with wireless protocols to communicate with a cellphone; having multispectral imaging sensors in an urban region, where the sensors might be fixed or mobile, located on the ground or on walls, roofs, ceilings or airborne; where the sensors have image recognition methods to track a pedestrian; with acoustic microphones, to record conversations; where a pedestrian (Jane) contacts SD with her cellphone, giving the phone's location, and SD then tracks her with imaging sensors; where SD uses prior knowledge of its surroundings to improve the image recognition tracking of Jane or other persons.

2. The method of claim 1, where, when Jane contacts SD, she points her phone at another person, and the phone's orientation is transmitted to SD, which then also tracks the person.

3. The method of claim 1, where, when Jane contacts SD, she points her phone at a vehicle, and SD then tracks any persons emerging from the vehicle and interacting with Jane; where SD optionally extracts the license of the vehicle and queries a government database with it.

4. The method of claim 1, where Jane's phone periodically transmits a beacon to improve SD's tracking of her.

5. The method of claim 4, where Jane's phone has a pseudorandom bit sequence in its beacon, where this sequence is known to SD.

6. The method of claim 1, where if a person comes into contact with Jane, any conversation is recorded and analysed for stress or excessive volume; and the person is tracked by SD.

7. The method of claim 6, where if the person goes into a vehicle, or was backtracked as coming from a vehicle, SD extracts its license from optical character recognition of the license plate, and queries a government database with it; if the vehicle is stolen, SD contacts the police and Jane's cellphone.

8. The method of claim 7, where if the person leaves in a vehicle, SD contacts a Vehicle Ad Hoc Network (VANET) that may be present on the roads, with a description of the vehicle, to have the VANET track it.

9. The method of claim 1, where SD coordinates with another similar device (SD′), so that coverage of Jane is maintained between sensors of SD and SD′, when SD relinquishes coverage.

10. The method of claim 1, when Jane contacts SD with her cellphone, and she is not in the image coverage of any of its sensors, then SD moves its mobile sensors to bring her within coverage; where SD replies with a suggested trajectory for Jane, to bring her within coverage of its sensors.

11. The method of claim 1, where SD contacts a Safety Kiosk (SK) enclosure that can offer shelter against other persons or the weather; where SD decides this based on a request from Jane, or from biometrics of her transmitted by her phone that suggests she needs assistance, or from observing that a stranger following her is recognised as a suspect in a government database; where SD gives directions to Jane to proceed to the SK; where SD instructs SK to admit Jane; where, if Jane enters SK, SD directs SK to close and not admit anyone else.

12. The method of claim 11, where an SK is also used as an enclosure for an Automated Teller Machine.

13. The method of claim 11, where an SK is also used as a single occupant toilet.

14. The method of claim 11, where an SK is a double door entrance to a building.

15. The method of claim 1, where Jane is in a Personal Mobility Device (PMD), and it contacts SD for a route through a region, and the route is downloaded and automatically executed on the PMD.

16. The method of claim 1, where Jane's phone has an electronic agent that downloads to the phone, calendar and map data and messages relating to or near the current time, appointment or location, and uploads these to SD for archival.

17. The method of claim 16, where the archival includes copying destinations (e.g. webpages) pointed to by links in the uploaded data.
